(19) United States
(12) Patent Application Publication
(10) Pub. No.: US 2014/0184050 A1
(43) Pub. Date: Jul. 3, 2014

(54) Lighting Apparatus

(71) Applicant: Kei MIZUTA, (US)

(72) Inventor: Kei MIZUTA, (US)

(73) Assignees: KAGOSHIMA UNIVERSITY, KAGOSHIMA (JP); MOLEX JAPAN CO., LTD., YAMOTO (KR)

(21) Appl. No.: 13/729,174

(22) Filed: Dec. 28, 2012

(51) Int. Cl. F21V 29/00

(52) U.S. Cl. CPC F21V 29/004
USPC 313/35; 313/45

(57) ABSTRACT

A lighting apparatus is provided with: a light-emitting unit, a heat spreader in heat-conductive contact with the light-emitting unit that diffuses the heat conducted from the light-emitting unit, heat pipes with one end in heat-conductive contact with the heat spreader that transport heat to their other end, and a lower row of cooling fins and upper row of cooling fins that are in heat-conductive contact with the other ends of the heat pipes, and that radiate the heat conducted from the heat pipes into the environment.

### REFERENCE TO RELATED APPLICATIONS

The Present Disclosure claims priority to Japanese Patent Application No. 2011-287839, entitled “Lighting Apparatus,” and filed 28 Dec. 2011 with the Japanese Patent Office. The content of this Application is incorporated in its entirety herein.

### BACKGROUND OF THE PRESENT DISCLOSURE

The Present Disclosure relates, generally, to a lighting apparatus, and, more particularly, to a lighting apparatus provided with a heat-radiating means which suppresses any increase in the temperature of the light-emitting element.

An apparatus equipped with a light-emitting element that provides illumination by means of visible light emitted by the light-emitting element is called a “lighting apparatus.” Generally, the light-emitting element refers to a light-emitting diode (LED) or other solid-state light-emitting element, but in this Specification, it refers to an entire apparatus that converts electrical energy into emitted visible light. Accordingly, in this Specification, incandescent lamps and fluorescent lamps are included in the category of a “light-emitting element.” In addition, the locations where the lighting apparatus may be used or the objects illuminated are not limited.

As defined above, the light-emitting element is an apparatus that converts electrical energy into visible light, but the efficiency of conversion thereof is not 100%. When electricity is passed through the light-emitting element, a non-negligible proportion of the electrical energy is converted to heat, which raises the temperature of the light-emitting element. Light-emitting diodes are light-emitting elements with a high efficiency of conversion but even they generate non-negligible amounts of heat. In addition, when the temperature of the light-emitting element increases, the performance of the light-emitting element and its lifetime drop.

In order to solve this problem, lighting apparati equipped with heat sinks or other heat-radiating members to cool the light-emitting element are known. For example, Japanese Patent Application No. 2009-204888, the content of which is incorporated herein in its entirety, discloses a lighting apparatus wherein a LED light-emitting unit is attached to one face of a cooling panel and also a hollow portion is provided on the other face and a water pipe communicates with this hollow portion, thus cooling the LED light-emitting unit. In addition, Japanese Patent Application No. 2010-240509, the content of which is also incorporated herein in its entirety, discloses a lighting apparatus provided with a heat accumulator connected to a LED light source that accumulates the heat generated by the LED light source and a heat sink that radiates the heat accumulated in the heat accumulator. The heat accumulator and heat sink of this lighting apparatus are aluminum plates, where the heat sink is mounted vertically upon the face opposite the face on which the heat accumulator for the LED light source is mounted.

The lighting apparatus disclosed in the aforementioned Japanese Patent Applications cool the light-emitting element with water or air, preventing damage to the light-emitting element and decreases in its performance. In addition, they permit the emission of high-intensity light. In other words, a high-intensity lighting apparatus can be achieved.

However, with the lighting apparatus of the '888 Application, cooling water runs through the water pipe, so there are problems with the time and costs required for installation. In addition, there is also a problem in that if the cooling water is allowed to run off; namely, if the cooling water, heated after absorbing the heat generated by the light-emitting element, is dumped as is, then the amount of cooling water consumed would be large. Although the amount of cooling water consumed can be reduced by recirculating the cooling water using an apparatus that releases the heat absorbed by the cooling water into the environment (e.g., a radiator), not only would this make the entire apparatus large but there is also the problem of the costs also becoming greater.

On the other hand, the lighting apparatus of the '509 Application is provided with a heat sink so that the light-emitting element is cooled with air, so the problems as described previously do not occur. However, the transport of heat generated by the light-emitting element to the heat sink is done by conduction of heat within a solid, so there is a limit to the heat-conduction performance. In addition, no particular consideration is given to the flow of air in the periphery of the heat sink, so there is a limit to the heat-radiation performance also. For this reason, there is a problem in that if one wishes to obtain the desired cooling capacity, the outside dimensions of the cooling means must be made greater.

In addition, outside dimensions of the conventional lighting apparati with cooling means are limited by the conditions of the installation location, so they cannot be made infinitely large. Ultimately, the intensity of the lighting apparatus are also limited by the conditions of the installation location. Thus, regarding the aforementioned Japanese Patent Applications, the problem is that apparati able to emit high-intensity light cannot be installed in small spaces.

### SUMMARY OF THE PRESENT DISCLOSURE

The Present Disclosure came about in consideration of the above background and has as an object to provide a compact and lightweight lighting apparatus that is able to emit high-intensity light. In order to achieve the aforementioned object, the lighting apparatus according to the Present Disclosure comprises a light-emitting element, a heat-diffusing member in heat-conductive contact with the light-emitting element that diffuses the heat conducted from the light-emitting element, a heat-transporting member with one end in heat-conductive contact with the heat-diffusing member that transports heat from the one end to its other end, and a heat-radiating member in heat-conductive contact with the other end of the heat-transporting member that radiates the heat conducted from the heat-transporting member into the environment. The heat-diffusing member may have a central portion that faces the light-emitting element and a surrounding portion that encloses all or part of the central portion. The heat-transporting member may be in heat-conductive contact with the heat-diffusing member in the surrounding portion.

In addition, the heat-radiating member may be disposed such that there is a gap between it and the heat-diffusing member, and air that flows in and downward through the gap along the heat-radiating member passes through the heat-radiating member and then flows upwards and out of the heat-radiating member. Moreover, the heat-radiating member may be provided with a plurality of rows of cooling fins, each comprising an array of a plurality of cooling fins with gaps in between. The rows of cooling fins may be disposed in layers arranged up and down.

Moreover, the plurality of rows of cooling fins may be arranged such that the cooling fins of one of two adjacent rows of cooling fins are disposed to cross the cooling fins of the other row of cooling fins, when viewed from above. Moreover, the plurality of rows of cooling fins are arranged such that the axis of the array of cooling fins of one of two adjacent rows of cooling fins is disposed so as to create a “twist” relationship with respect to the axis of the array of the other row of cooling fins, when viewed from above. Alternatively, the axes of the arrays of two adjacent rows of cooling fins may be disposed so as to be perpendicular to each other.

Moreover, the cooling fins may be provided with a notch at least one of their side edges, and the notches of one of a pair of the adjacent rows of cooling fins may fit into the notches of the other of the pair of adjacent rows of cooling fins. Moreover, the surface areas of each of the adjacent cooling fins may be different from each other. In addition, the light-emitting element may mounted upon a substrate, and the substrate may be in surface contact with the heat-diffusing member. In addition, a base in surface contact with the heat-diffusing member may be provided and also, one end of the heat-transporting member may be connected to the base. In addition, a plurality of units of the aforementioned lighting apparatus may be combined.

With the Present Disclosure, the lighting apparatus is provided with heat-diffusing members, heat-transporting members and heat-radiating members, so the heat generated by the light-emitting element can be efficiently radiated into the environment, and thus the lighting apparatus can be made more compact and lightweight. In addition, the lighting apparatus is able to emit high-intensity light. For that reason, it is possible to install lighting apparatus able to emit high-intensity light even in small spaces.

### BRIEF DESCRIPTION OF THE FIGURES

The organization and manner of the structure and operation of the Present Disclosure, together with further objects and advantages thereof, may best be understood by reference to the following Detailed Description, taken in connection with the accompanying Figures, wherein like reference numerals identify like elements, and in which:

FIG. 1 is an illustration of the outside of a lighting apparatus that presents an embodiment of the Present Disclosure, where (a) is a perspective view and (b) is a view when seen in the Direction B;

FIG. 2 is a perspective view of the exterior of the light-emitting unit;

FIG. 3 is a perspective view illustrating the exterior of the base;

FIG. 4 is a perspective view illustrating the exterior of the heat pipes;

FIG. 5 is a perspective view illustrating the exterior of the lower row of cooling fins and the upper row of cooling fins;

FIG. 6 is a perspective view illustrating the positional relationships among the light-emitting unit, heat spreader and base, where (a) is a plan view and (b) is a cross section along the Line BB′;

FIG. 7 is a diagram illustrating the flow of cooling air around the periphery of the lighting apparatus;

FIG. 8 is a perspective view illustrating a variation of the lighting apparatus;

FIG. 9 is a perspective view illustrating another variation of the lighting apparatus; and

FIG. 10 is a perspective view illustrating the lighting apparatus of FIG. 9 with the cooling fins of one set of heat-radiating units removed.

### DESCRIPTION OF THE PREFERRED EMBODIMENTS

While the Present Disclosure may be susceptible to embodiment in different forms, there is shown in the Figures, and will be described herein in detail, specific embodiments, with the understanding that the Present Disclosure is to be considered an exemplification of the principles of the Present Disclosure, and is not intended to limit the Present Disclosure to that as illustrated.

As such, references to a feature or aspect are intended to describe a feature or aspect of an example of the Present Disclosure, not to imply that every embodiment thereof must have the described feature or aspect. Furthermore, it should be noted that the description illustrates a number of features. While certain features have been combined together to illustrate potential system designs, those features may also be used in other combinations not expressly disclosed. Thus, the depicted combinations are not intended to be limiting, unless otherwise noted.

In the embodiments illustrated in the Figures, representations of directions such as up, down, left, right, front and rear, used for explaining the structure and movement of the various elements of the Present Disclosure, are not absolute, but relative. These representations are appropriate when the elements are in the position shown in the Figures. If the description of the position of the elements changes, however, these representations are to be changed accordingly.

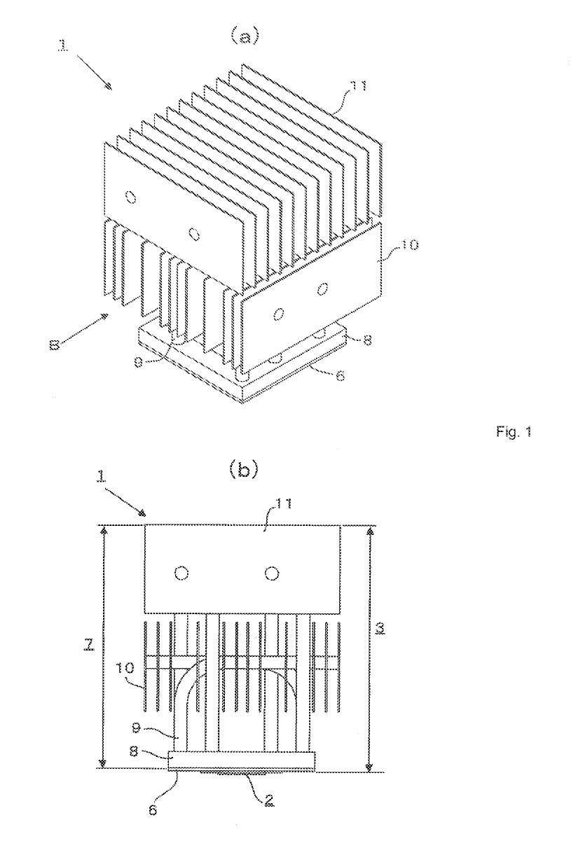

Referring to the Figures, FIG. 1 is an illustration of the outside of a lighting apparatus that presents an embodiment of the Present Disclosure. The lighting apparatus 1 is constituted by attaching a cooling unit 3 to a light-emitting unit 2. The light-emitting unit 2 is a unit equipped with a light-emitting element and emits illuminating light, while the cooling unit 3 is a unit that is in heat-conductive contact with the light-emitting unit 2 to cool the light-emitting unit 2. Note that in this Specification, “A and B are in heat-conductive contact” means that A and B are in direct or indirect contact, so that the movement of heat between A and B is possible. Accordingly, even cases in which a substance or apparatus that transports heat between A and B are also considered “heat-conductive contact.”

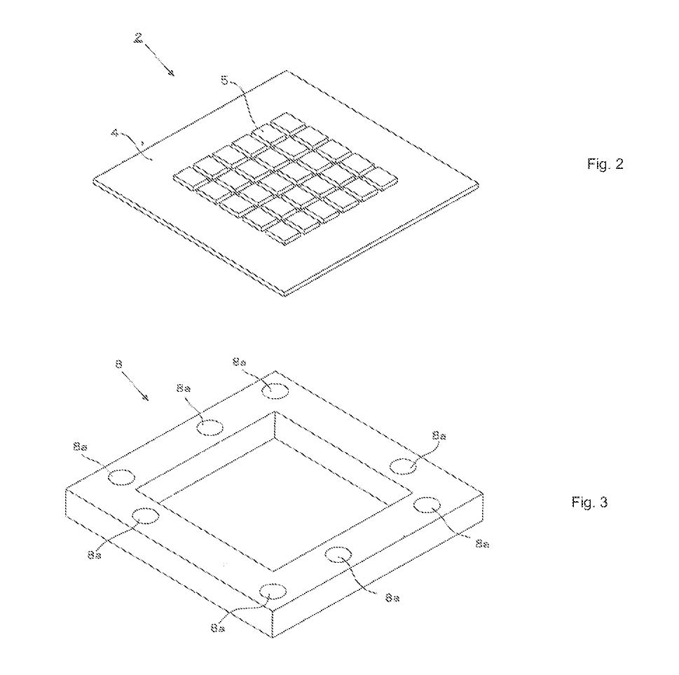

As shown in FIG. 2, the light-emitting unit 2 has a plurality of LEDs 5 mounted upon one face of a substrate 4. In addition, the other face of the substrate 4, or the face upon which the light-emitting diodes 5 are not mounted, is in physical contact with the cooling unit 3 (see FIG. 1(b)). In addition, the substrate 4 is a heat-conductive material. For this reason, heat generated by the light-emitting diodes 5 flows through the substrate 4 to the cooling unit 3. Thus, the light-emitting diodes 5 are in heat-conductive contact with the cooling unit 3.

As shown in FIG. 1, the cooling unit 3 comprises a heat spreader 6 and a heat-radiating unit 7, where the heat-radiating unit 7 is provided with heat pipes 9, lower row of cooling fins 10 and upper row of cooling fins 11. The heat spreader 6 is a type of plate-shaped heat pipe where, in the interior of a copper casing, coolant paths extending from the center to the periphery of the casing are provided, and the interior of the coolant paths are filled with fluids that function as coolants (e.g., water, ethanol, methanol, acetone, etc.). Note that the specific constitution of the heat spreader 6 is already publicly known, so we shall omit a detailed explanation thereof. If necessary, please refer to the publication of Japanese Patent No. 4,047,918, for example, the content of which is hereby incorporated by reference herein in its entirety.

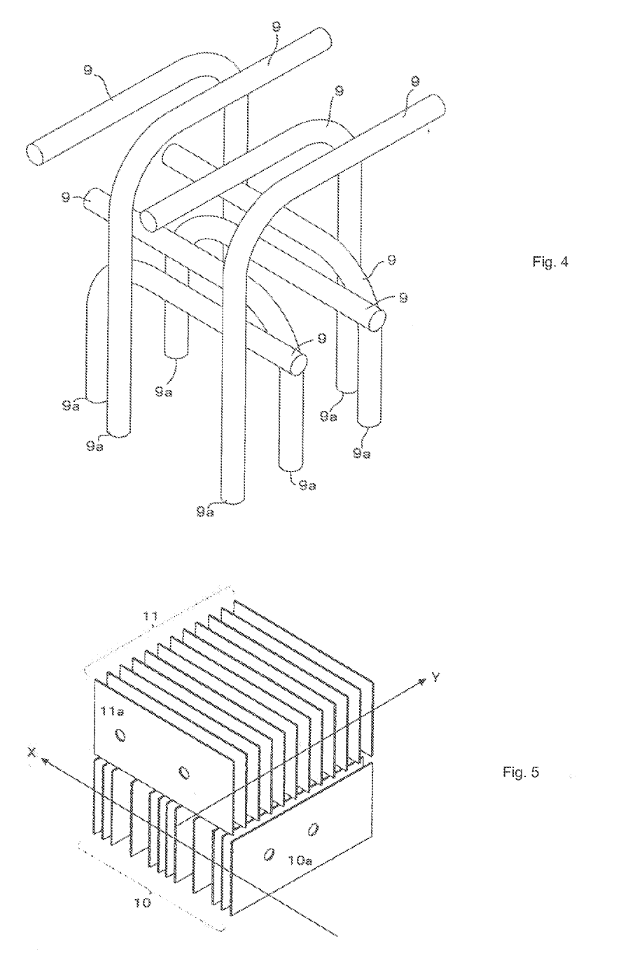

As shown in FIG. 3, the base 8 is a solid metal part that has a planar shape substantially in a square shape, in which are formed holes 8a for installing the heat pipes 9. As shown in FIG. 4, the cooling unit 3 is provided with eight heat pipes 9. The heat pipes 9 are “L” shaped overall, having one end 9a installed in the holes 8a of the base 8 (see FIG. 3), rising vertically and then bending at a roughly 90 degree angle and inserted into the lower row of cooling fins 10 or upper row of cooling fins 11 (see FIG. 1(b)) and are thus in heat-conducting contact with the lower row of cooling fins 10 or upper row of cooling fins 11. To wit, each of the heat pipes 9 is inserted into one of the cooling fins 10a, 11a constituting the lower row of cooling fins 10 or the upper row of cooling fins 11, being in heat-conducting contact at the insertion point. With such a constitution, the heat pipes 9 can transport heat from the base 8 to the cooling fins 10, 11.

Note that the heat pipes 9 are pipe-shaped heat transport members, and their principle of operation is the same as that of the heat spreader 6. To wit, the heat pipes 9 are made of copper or other material that is a good heat conductor that are filled with water, ethanol, methanol, acetone or other coolant, while in the interior of the pipes are formed vapor flow paths where coolant vapor flows and liquid flow paths where liquefied coolant flows. Note that the liquid flow paths may be simple tubes or flow paths that make use of the capillary effect. If it is possible to make use of the capillary effect, then it is possible for liquid to move regardless of the attitude of the heat pipes 9. For example, it would be possible for liquid to move against gravity (from bottom to top). The heat pipes 9 are already known apparatus that are available on the market, so we shall omit a detailed explanation of the structure and constitution and the like of the heat pipes 9.

As shown in FIG. 5, the lower row of cooling fins 10 and upper row of cooling fins 11 are heat-diffusing members comprising a plurality of cooling fins 10a, 11a disposed parallel to each other with a gap between. The lower row of cooling fins 10 and upper row of cooling fins 11 are disposed in layers, with the axis of orientation X of the lower row of cooling fins 10 (the axis passing through the geometric centers of the cooling fins making up the row of cooling fins) and the axis of orientation Y of the upper row of cooling fins 11 being perpendicular to each other. Accordingly the axes of orientation have a “twist” relationship with each other. Note that the cooling fins 10a, 11a are made of any heat-conductive material (e.g., metal materials, highly heat-conductive plastics, engineering plastics, graphite, etc.). In addition, as shown in see FIG. 1(b), the lower row of cooling fins 10 is disposed separated from the base 8 by a gap. Note that the lower row of cooling fins 10 and upper row of cooling fins 11 each comprise twelve cooling fins 10a, 11 a each, but to avoid complexity, only one of the fins is labeled in FIG. 5.

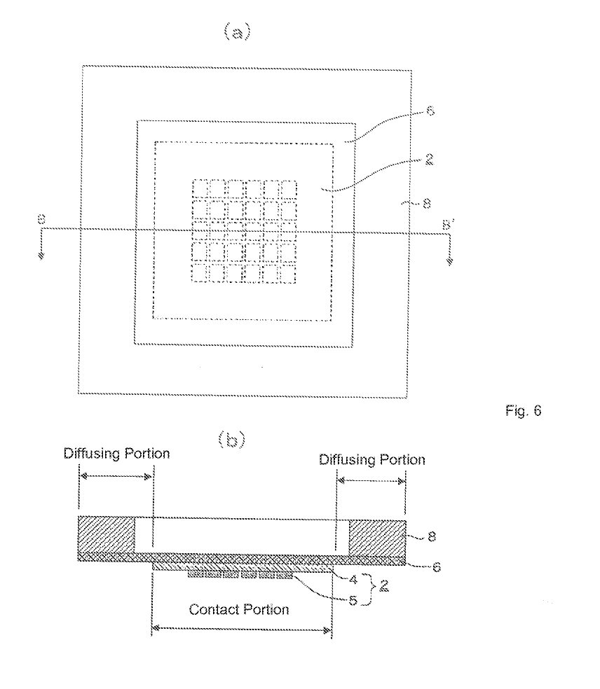

The light-emitting unit 2, heat spreader 6 and base 8 are connected as shown in FIG. 6. To wit, the light-emitting unit 2 is at one face of the heat spreader 6, and connected and attached so that the light-emitting diodes 5 are positioned near the center of the heat spreader 6. For convenience in explanation, the area of the heat spreader 6 in contact with the light-emitting unit 2 is called the “contact area.” In addition, the base 8 is at the other face of the heat spreader 6 and is connected directly and attached to the periphery of the heat spreader 6. For convenience in explanation, the area of the heat spreader 6 in contact with the base 8 is called the “diffusion area.” When the heat spreader 6 is seen in top view, the diffusion area surrounds the contact area.

With this constitution, the heat from the light-emitting unit 2 passes through the contact area and flows into the heat spreader 6, and is then transported to the diffusion area and flows to the base 8. For this reason, any increases in the temperature of the contact area are suppressed. In other words, the contact area does not get hot (no hot spots occur). This reduces the thermal resistance between the light-emitting unit 2 and the heat spreader 6.

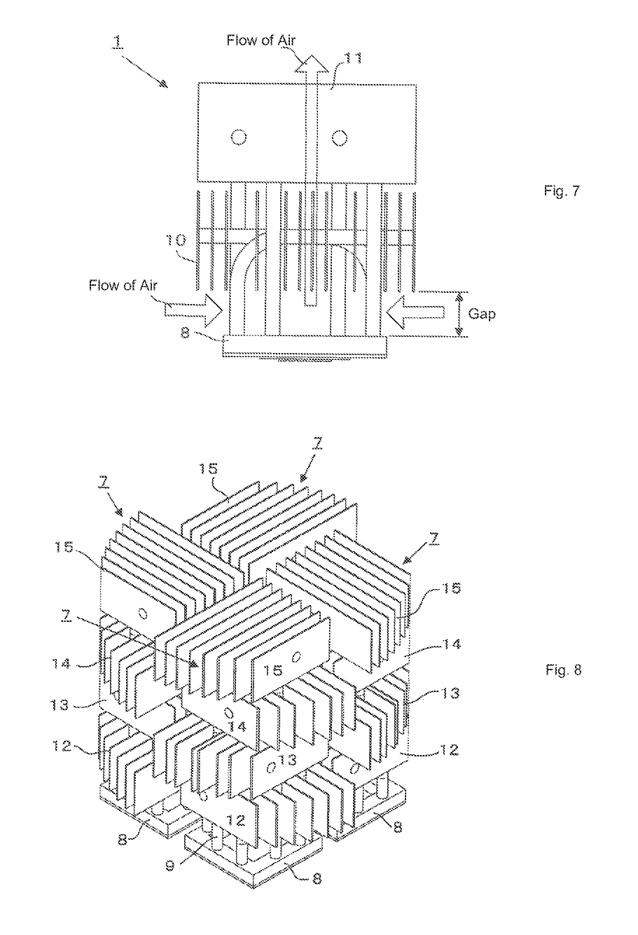

Heat flowing into the base 8 passes through the heat pipes 9 and is transported to the lower row of cooling fins 10 and upper row of cooling fins 11 (in the following, both are collectively called the “rows of cooling fins”), from which it is diffused and radiated into the environment. At this time, the air (cooling air) flows as shown in FIG. 7. To wit, cooling air flows in from the “gap” between the base 8 and the lower row of cooling fins 10, enters the rows of cooling fins, and the cooling air that has absorbed heat (or namely became hotter) from the rows of cooling fins becomes less dense, rising through the rows of cooling fins and ultimately exiting from the upper surface of the upper row of cooling fins 11. In this manner, a flow of cooling air is generated by the heat radiated from the rows of cooling fins.

In this manner, the cooling air flows in from the bottom of the lower row of cooling fins 10 and rises between the cooling fins 10a while extracting heat from the cooling fins 10a, but during this period, temperature boundary layers are reached in the cooling air among the cooling fins 10a. To wit, the temperature boundary layers become thicker. In such a case, then heat is less easily transferred to the relatively cooler cooling air outside the temperature boundary layers, so the efficiency of radiation of heat by the cooling fins 10a decreases. However, the axis of orientation Y of the upper row of cooling fins 11 is perpendicular to the axis of orientation X of the lower row of cooling fins 10, so when cooling air that has left the lower row of cooling fins 10 (cooling fins 10a) enters the upper row of cooling fins 11, relatively cool air which was outside the temperature boundary layer in the lower row of cooling fins 10 comes into direct contact with the cooling fins 11a. For this reason, the cooling fins 11a radiate heat efficiently.

In this manner, the lighting apparatus 1 can efficiently radiate heat generated by the light-emitting diodes 5 into the environment and effectively cool the light-emitting diodes 5. For this reason, the light-emitting diodes 5 can emit high-intensity light. In addition, the lighting apparatus 1 can be more compact and lightweight than conventional units of equal light intensity.

Note that the above embodiment is one example of an embodiment of the Present Disclosure, but the technical scope of the Present Disclosure is in no way limited to the above embodiment. The Present Disclosure may be freely adapted, modified or improved within the scope of the technical concept recited in the Claims.

For example, the shape and dimensions of the lighting apparatus 1 are given as examples and are not limited to those presented on the various Figures. The planar shape of the heat spreader 6 may be a polygon other than a rectangle and may even be circular. The planar shapes of the cooling fins 10a or 11 a are also not limited to rectangular.

In addition, the substrate 4 and base 8 are optional constituent elements and may be omitted. For example, the light-emitting diodes 5 may be mounted directly upon the heat spreader 6. In addition, the heat pipes 9 may be attached directly to the heat spreader 6.

In addition, the lighting apparatus 1 may also have additions to the configuration illustrated above. For example, it may be also provided with a casing, probe, lens, reflector, etc. In addition, circuits for the purpose of lighting the light-emitting diodes 5 may also be built in.

In addition, in the above embodiment, the heat spreader 6 is given as a specific example of the heat-diffusing member, but the heat-diffusing member is in no way limited to the heat spreader 6. It may be a plate or chunk of copper or aluminum, for example, or anything that utilizes heat conduction by a solid. Naturally, if the heat spreader 6 is provided as the heat-diffusing member, then the cooling capacity of the lighting apparatus 1 is increased in comparison to the case of a plate or chunk of copper or aluminum being provided as the heat- diffusing member.

The embodiment above illustrates an example in which the contact area disposed at the center of the heat spreader 6 is surrounded by the diffusion area disposed in the periphery of the heat spreader 6 in a square shape, but its planar shape is not limited to the shape as long as the diffusion area is in the periphery of the heat spreader 6. For example, there may be portions where the diffusion area may not be provided in a portion of the periphery of the heat spreader 6. To wit, the planar shape of the diffusion area may resemble the symbol “ [symbol] ” or the symbol “ [symbol] ”.

In addition, the embodiment above illustrates an example in which the upper row of cooling fins 11 and upper row of cooling fins 11 are shown as specific examples of the heat-radiating members, but the mode or shape of the heat-radiating members are not limited thereto. For example, it is possible to provide only one row of cooling fins, or three or more rows may also be provided. Alternately, three or more rows of cooling fins may be stacked up with the directions of their axes of orientation varied from each other.

For example, as shown in FIG. 8, four sets of heat-radiating units 7 may be disposed in the shape of the symbol “ [symbol] ” and the light-emitting unit 2 may be attached to the various heat-radiating units 7 with heat spreaders 6 interposed (not shown in FIG. 8), thus constituting the lighting apparatus 1 (not shown in FIG. 8). In addition, the heat-radiating units 7 may include four stacked rows of cooling fins 12-15, with the directions of the axes of orientation of cooling fin rows 12 and 14 and the axes of orientation of cooling fin rows 13 and 15 perpendicular to each other, and thus the adjacent axes of orientation are in a “twist” relationship.

In addition, in the embodiment in FIG. 1, for example, for each row of cooling fins 10, two sets of paired heat pipes 9 bent so as to face each other, or namely a total of four heat pipes 9 are provided, but in the embodiment in FIG. 8, for cooling fin row 12 one set of paired heat pipes 9 bent so as to face each other, or namely a total of two are provided. In the same manner, for cooling fin rows 13-15 one set of paired heat pipes 9, or namely a total of two heat pipes 9 are provided. In this manner, the heat-radiating unit 7 which has four stacked rows of cooling fins 12-15 is provided with a total of eight heat pipes 9.

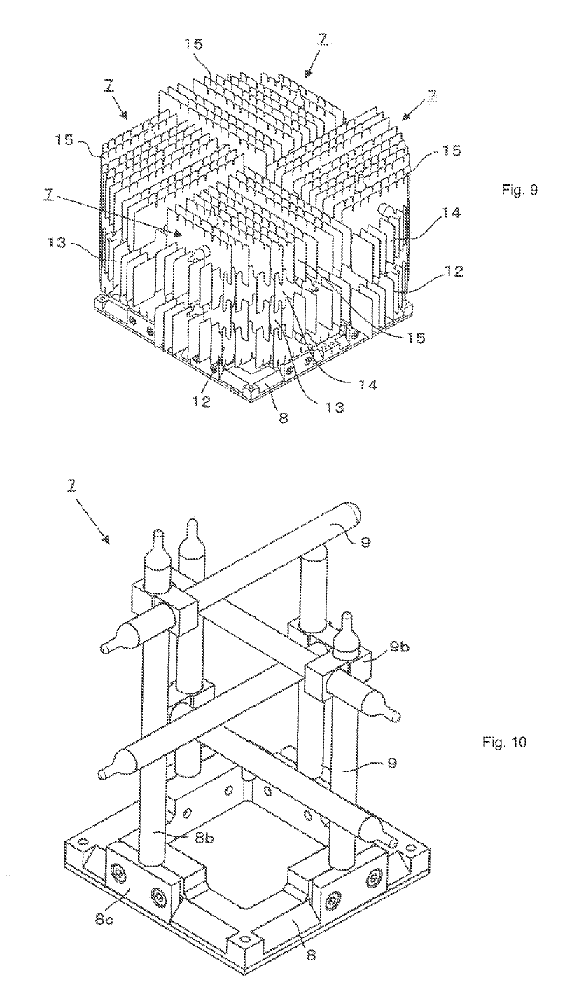

In addition, as shown in FIG. 9, a portion of the rows of cooling fins 12-15 may be disposed such that they are stacked upon each other. To wit, notches are provided in the cooling fins constituting a row of cooling fins, and the other adjacent rows of cooling fins may be inserted into the notches, thus lowering the overall height of the heat-radiating unit 7.

Note that the heat pipes 9 explained with the embodiments in FIGS. 1 and 8 have an overall “L” shape but as shown in FIG. 10, in the embodiment in FIG. 9, two straight tube-shaped heat pipes 9 are disposed in the vertical and horizontal directions with respect to the base 8. In addition, these two heat pipes 9 are joined using a joint member 9b, thus forming joined heat pipes that extend in the vertical and horizontal directions. Note that FIG. 10 illustrates the lighting apparatus of FIG. 9 with the cooling fins of one set of heat-radiating units removed.

The heat-radiating unit 7 shown in FIG. 10 is formed from a base 8, four heat pipes 9 in heat-conductive contact with this base 8 which extend in the vertical direction, four heat pipes 9 in heat-conductive contact with the rows of cooling fins which extend in the horizontal direction, and four joint members 9b which connect these heat pipes 9 to each other. In short, it is sufficient for the base 8 and the cooling fin rows 10-15 to be in heat-conductive contact via heat pipes.

In addition, in FIGS. 9-10, the heat pipes 9 are secured by securing members 8c fastened from outside into indentations 8b formed in the side walls of the base 8, but they may also be connected by any method as long as at least the heat pipes 9 and base 8 are thermally connected. In addition, the cooling fin rows 12-15 shown in FIGS. 8-9 have cooling fins that differ in surface area from the adjacent cooling fins. Specifically, in the cooling fin row 12 of heat-radiating unit 7 in FIGS. 8-9, the surface area of adjacent cooling fins 12a decrease gradually along the axis of orientation of the cooling fins. Thereby, as shown in FIG. 8, when four heat-radiating modules 7 are disposed, the overall shape of the lighting apparatus 1 is cylindrical, and as a result the lighting apparatus can be made more compact and lightweight. Note that as shown in FIGS. 8-9, the other cooling fin rows 13-15 have the same constitution as that of cooling fin row 12.

In addition, the above embodiments illustrate examples in which the axis of orientation Y of the upper row of cooling fins 11 is perpendicular to the axis of orientation X of the lower row of cooling fins 10, but it is sufficient for there to be a “twist” relationship between axis of orientation X and axis of orientation Y, so they may cross at other angles also. In short, it is sufficient for the air which is outside the temperature boundary layer generated while flowing through the lower row of cooling fins 10 to strike the upper row of cooling fins 11.

In addition, while the above embodiment was illustrated using light-emitting diodes 5 as a specific example of the light-emitting element, the technical scope of the Present Disclosure is not limited to lighting apparatus in which light-emitting diodes are the light source. The light source may be another type of solid-state light-emitting element, for example an electroluminescent (EL) element. In addition, the light-emitting elements may also be incandescent lamps or discharge (fluorescent) lamps. In addition, the light-emitting element may also be any future light source.

The Present Disclosure has its original purpose in permitting the emission of high-intensity light by lighting apparatus equipped with light-emitting diodes or the like, and also making the lighting apparatus more compact and lightweight, but the same applies to lighting apparatus that uses incandescent lamps or discharge (fluorescent) lamps in which high-intensity light emission and compactness and light weight are contradictory. Accordingly, it is important to apply the Present Disclosure to such lighting apparatus.

In addition, in the above explanation of embodiments, although no specific mention was made of the means of joining the individual constituent elements, it is possible to use known means including, for example, crimping, welding, brazing and threading. In addition, in the joining of heat pipes to fins, it is possible to use means including, for example, pressing-in, adhesion, soldering, welding, fusing and others.

What is claimed is:

1. A lighting apparatus comprising:
a light-emitting element;
a heat-diffusing member in heat-conductive contact with the light-emitting element that diffuses the heat conducted from the light-emitting element;
a heat-transporting member with one end in heat-conductive contact with the heat-diffusing member that transports heat from the one end to its other end; and
a heat-radiating member in heat-conductive contact with the other end of the heat-transporting member that radiates the heat conducted from the heat-transporting member into the environment.

2. The lighting apparatus of claim 1, wherein the heat-diffusing member has a central portion that faces the light-emitting element and a surrounding portion that encloses all or part of the central portion.

3. The lighting apparatus of claim 2, wherein the heat-transporting member is in heat-conductive contact with the heat-diffusing member in the surrounding portion.

4. The lighting apparatus of claim 3, wherein the heat-radiating member is disposed such that there is a gap between it and the heat-diffusing member, and air that flows in and downward through the gap along the heat-radiating member passes through the heat-radiating member and then flows upwards and out of the heat-radiating member.

5. The lighting apparatus of claim 4, wherein the heat-radiating member is provided with a plurality of rows of cooling fins, each comprising an array of a plurality of cooling fins with gaps in between them.

6. The lighting apparatus of claim 5, wherein the plurality of rows of cooling fins are disposed in layers arranged up and down.

7. The lighting apparatus of claim 6, wherein the plurality of rows of cooling fins are arranged such that the cooling fins of one of two adjacent rows of cooling fins are disposed so as to cross the cooling fins of the other row of cooling fins, when viewed from above.

8. The lighting apparatus of claim 7, wherein the plurality of rows of cooling fins are arranged such that the axis of the array of cooling fins of one of two adjacent rows of cooling fins is disposed so as to create a “twist” relationship with respect to the axis of the array of the other row of cooling fins, when viewed from above.

9. The lighting apparatus of claim 8, wherein the axes of the arrays of two adjacent rows of cooling fins are disposed so as to be perpendicular to each other.

10. The lighting apparatus of claim 9, wherein the cooling fins are provided with a notch at least one of their side edges.

11. The lighting apparatus of claim 10, wherein the notches of one of a pair of the adjacent rows of cooling fins fit into the notches of the other of the pair of adjacent rows of cooling fins.

12. The lighting apparatus of claim 11, wherein the surface areas of each of the adjacent cooling fins are different from each other.

13. The lighting apparatus of claim 12, wherein the light-emitting element is mounted upon a substrate, and the substrate is in surface contact with the heat-diffusing member.

14. The lighting apparatus of claim 13, wherein a base in surface contact with the heat-diffusing member is provided and also, one end of the heat-transporting member is connected to the base.
